(19) United States
(12) Patent Application Publication
(10) Pub. No.: US 2003/0121192 A1
(43) Pub. Date: Jul. 3, 2003

(54) Receiver hitch bumper sticker display

(76) Inventor: Steven Richard McPheters, Dekalb, IL (US)

Correspondence Address: Steve Mcpheters, 1123 Lewis Street Apt. A, Dekalb, IL, 60115, US

(21) Appl. No.: 10/028,948

(22) Filed: Dec. 27, 2001

(51) Int. Cl. G09F 21/04

(52) U.S. Cl. 40/591

(57) ABSTRACT

A display system comprised of a display and a receiver tube that can be mounted to the receiver hitch of a vehicle. The display of this system can accommodate both adhesive backed labels and signs that require mechanical attachment. The receiver tube of this system can be used with either a 1¼ inch receiver hitch or 2 inch receiver hitch. The receiver tube of this display system can accommodate various sizes of hitch-mounting pins. The display of this system can be lighted or non-lighted.

### FIELD OF THE INVENTION

This invention relates to display of bumper stickers on vehicles. More specifically, this invention relates to a method of displaying bumper stickers using the trailer hitch opening on a vehicle.

### BACKGROUND OF INVENTION

Bumper stickers have been displayed on vehicles for more than 30 years. Over time these bumper stickers weather, become unsightly, and are difficult to remove. As the cost of vehicles has risen, many vehicle owners have chosen not to attach bumper stickers to their vehicles. This invention provides a location for the display of bumper stickers. With this invention, vehicle owners do not have to worry about damaging the finish of vehicles. This invention also provides an attractive way of filling the unsightly hole left in a receiver hitch after the trailer hitch has been removed.

### DESCRIPTION OF PRIOR ART

Currently, there are no other devices similar to this invention. There are various types of hitch plugs, hitch covers, and hitch accessories that are being marketed to fill the open hole in the receiver hitch, but none of these other devices allows for the display of bumper stickers.

### SUMMARY OF THE INVENTION

The bumper sticker display of the present invention allows a vehicle owner to safely display bumper stickers with out damaging the finish of their vehicles. The display is designed to fit into the receiver hitch opening that is exposed when the trailer hitch is removed. The display is large enough to accommodate all sizes of bumper stickers and license plate sized sign plates. The bumper sticker display is available in two versions. The bumper sticker display is lighted with a license plate style lamp for visibility in the dark. A wiring adapter that plugs directly into accessory lighting terminal of the trailer wiring harness provides the power for the display light. The non-lighted display is identical to the lighted display, except without the light fixture. The bumper sticker displays are made from 14-gauge hot rolled steel. All of the joints are lap welded to ensure quality and reliability. The finished bumper sticker display is powder coated in order to provide a long lasting, durable paint finish. The bumper sticker displays are available in two sizes to accommodate both 1¼″ and 2″ receiver hitches.

### BRIEF DESCRIPTION OF THE DRAWINGS

FIG. 1 is a rear perspective view of the non-lighted bumper sticker display.

FIG. 2 is a side perspective view of the non-lighted bumper sticker display.

FIG. 3 is a rear perspective of the lighted bumper sticker display.

FIG. 4 is a side perspective of the lighted bumper sticker display.

FIG. 6 is a rear perspective of the standard bumper sticker display.

FIG. 7 is a side perspective of the standard bumper sticker display.

### DETAILED DESCRIPTION OF THE DRAWINGS

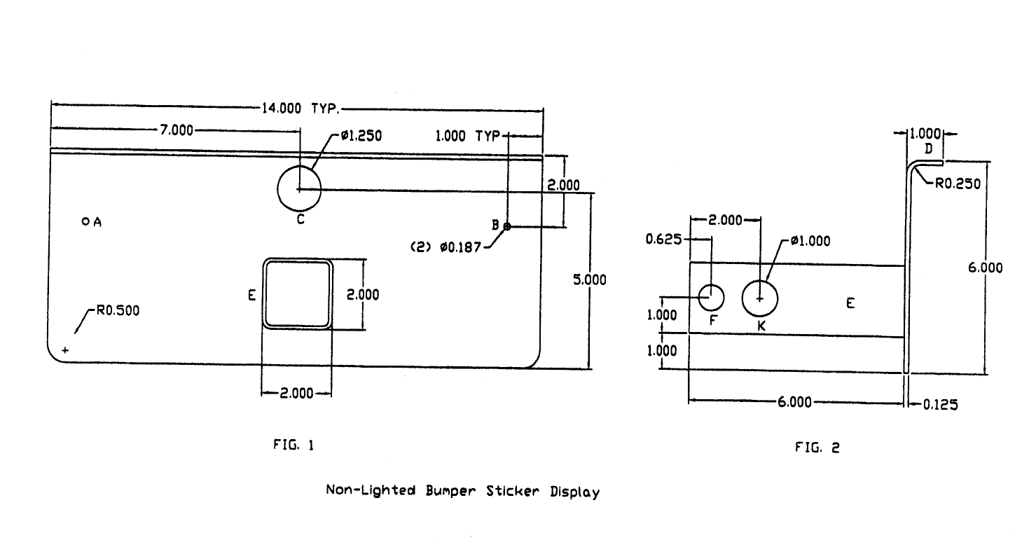

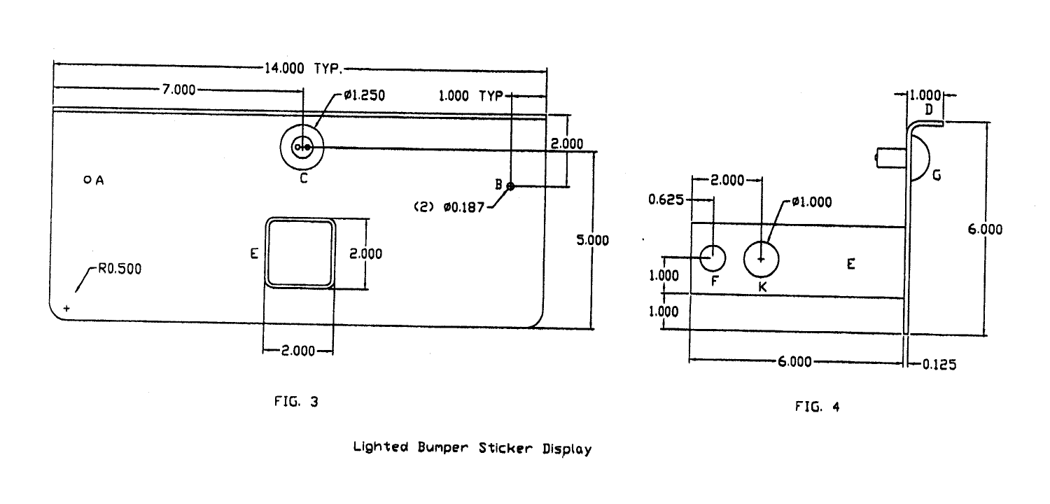

Referring to FIGS. 1 & 3, the lighted and the non-lighted bumper sticker displays are 14.0-inches wide by 6.0-inches tall. Two (2) 0.375-inch holes (A and B) have been drilled into the displays 4.0-inches from the bottom and 1.0-inches from the sides. These holes are used to attach license plate type signs to the display. A centrally located 1.25-inch hole (C) has been cut into the displays 5.0-inches on center from the bottom of the display. This hole allows for the insertion of a standard license plate lamp.

Referring to FIGS. 2&4, A 1.0-inch hood with a 0.250 radius (D) have been formed into the displays to prevent light from shinning up onto the vehicle. The receiver tubes (E) are 6.0-inches long and is centrally located 2.0-inches on center from the bottom of the display. The receiver tubes are fully welded on to the displays using a filet welds. A 0.725-inch hole (F) has been cut into the receiver tubes on a 0.625-inch center and a 1.0-inch hole (K) has been cut into the receiver tube on a 2.0-inch center to accept the receiver hitch pins that are used to lock the displays into the hitch receivers.

Referring to FIG. 4, The license plate lamp (G) is a commercially available lamp that is designed to fit into a 1.25-inch hole.

Referring to FIG. 5, the standard bumper sticker display is 14.0-inches wide by 4.0-inches tall.

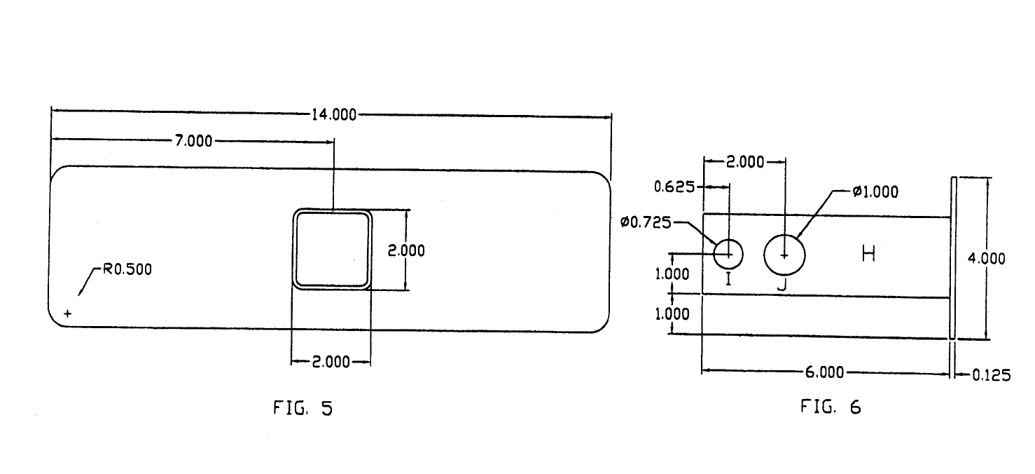

Referring to FIG. 6, The receiver tube (H) are 6.0-inches long and is centrally located 2.0-inches on center from the bottom of the display. The receiver tube is fully welded on to the display using a filet weld. A 0.725-inch hole (I) has been cut into the receiver tube on a 0.625-inch center and a 1.0-inch hole (J) has been cut into the receiver tube on a 2.0-inch center to accept the receiver hitch pins that are used to lock the displays into the hitch receivers.

### DRAWINGS

See attached drawings, Non-lighted Bumper Sticker Display, Lighted Bumper Sticker Display, and Standard Bumper Sticker Display.

What is claimed:

1. A display that can be mounted to the receiver hitch of a vehicle.

2. A display of claim 1 that is lighted.

3. A display of claim 1 that is not lighted.

4. A display of claim 1 that is made of painted metal.

5. A display of claim 1 that is made of colored plastic.

6. A display of claim 1 that fits to a 2 inch receiver hitch.

7. A display of claim 1 that fits to a 1¼ inch receiver hitch.

8. A display of claim 1 that can accommodate various sizes of hitch mounting pins.
